(19) United States
(12) Patent Application Publication
(10) Pub. No.: US 2017/0039183 A1
(43) Pub. Date: Feb. 9, 2017

(54) Metric Labeling for Natural Language Processing

(71) Applicant: NEC Laboratories America, Inc., Princeton, NJ (US)

(72) Inventors: Bing Bai, Princeton Junction, NJ (US); Yusuf Osmanlioglu, Philadelphia, PA (US)

(21) Appl. No.: 15/208,558

(22) Filed: Jul. 12, 2016

Related U.S. Application Data
(60) Provisional application No. 62/202,227, filed on Aug. 7, 2015.

(51) Int. Cl. G06F 17/27

(52) U.S. Cl. CPC G06F 17/2785; G06F 17/2705; G06F 17/274

(57) ABSTRACT

Systems and methods are disclosed for Natural Language Processing (NLP) by applying metric labeling to sentence matching problem by preprocessing a dataset of sentences into objects graphs and label graphs; given an object graph and a label graph, assigning nodes of the object graph to the nodes of the label graph by minimizing an objective function including an assignment cost and a separation cost; and applying the metric labeling to matching two sentences where the objective function value is used as a similarity score between sentences for classification, clustering, or ranking.

This application claims priority to Provisional Application 62/202,227 filed Aug. 7, 2015, the content of which is incorporated by reference.

### BACKGROUND

The present invention is related to NLP systems and methods.

Automated understanding of natural language is a problem studied under several disciplines including computer science, linguistics, and statistics. One major problem in natural language processing (NLP) is information retrieval which aims finding an item among a large dataset that satisfies a certain query. This problem has a wide application area from simple tasks such as making a keyword search among emails to complex tasks as obtaining statistics of patients that are diagnosed with a certain disease among a database of medical records written in natural language. The most fundamental method applied in information retrieval is statistically indexing terms, a process that is referred to as bag-of-words model. Although successfully applied in various application domains, one major drawback of this method is that it does not capture the semantic relations between words within a sentence and between neighboring sentences. One of the biggest challenges in this sense is detecting negation which can change the meaning of a phrase to its opposite. While negation might arise through use of terms such as not or no, or suffixes such as “n′t”, it might also occur due to words carrying negative meaning such as “denying”, “doubt”, or “unlikely”. Recently, deep neural networks learn from user supplied data for sentiment analysis. However, such systems require a vast amount of domain specific ground truth data for training which might be harder to obtain for many application areas due to limited resources of experts. Problem of negation detection is also investigated in specific application domains such as electronic medical records. Detecting coreferences within the text is another challenge that needs to be addressed in order to achieve accurate classification results. Specifically, nouns and the pronouns that refer to them need to be analyzed together when making a decision about the meaning of a sentence.

### SUMMARY

Systems and methods are disclosed for Natural Language Processing (NLP) by applying metric labeling to sentence matching problem by preprocessing a dataset of sentences into objects graphs and label graphs; given an object graph and a label graph, assigning nodes of the object graph to the nodes of the label graph by minimizing an objective function including an assignment cost and a separation cost; and applying the metric labeling to matching two sentences where the objective function value is used as a similarity score between sentences for classification, clustering, or ranking.

Advantages of the preferred embodiments may include one or more of the following. The system has superior sentiment recognition of natural language. Balancing CPU and network provides an efficient system that trains the language models quickly and with low running costs. More accurate sentiment models, with faster training times ensures that all businesses and applications such as job recommendations, internet help desks, etc. provide more accurate results.

### BRIEF DESCRIPTION OF THE DRAWINGS

FIGS. 1A-1B show exemplary graph representation of a sample sentence.

FIG. 2 shows an exemplary process for metric labeling with an object and a label graph.

FIGS. 3-4 show another exemplary process for metric labeling by minimizing cost and distribution weight.

FIG. 5 shows an exemplary system for processing NLP.

### DESCRIPTION

In one embodiment, the system handles movie review classification by sentiment value: Given a movie review, assume that we are asked to decide if the review has a positive sentiment about the movie “The Lord of the rings—Fellowship of the rings”. There are several challenges present with this problem. Firstly, the words lord, rings, and fellowship might be present in the review of some other movie referring to name of objects instead of being used as the proper name of the movie. Secondly, the review might belong to another movie where the book “The lord of the rings” is mentioned. Another challenge would be to describe the movie with its actors or the director, for example, without mentioning film's proper name, which needs to be detected from the overall review or some background information. Following example demonstrates this challenge: “Screen adaptation of Tolkien's masterpiece is not as striking as the novel itself.”

We aim to overcome above mentioned challenges by extending the traditional metric labeling formulation. Metric labeling formulation is an efficient way of matching two metric graphs. A one-to-one or one-to-many matching is obtained as a result along with an objective value which can be used as a similarity measure between the two graphs. It is known that sentences can be represented using graphs, albeit not necessarily defining a metric. Thus, we are interested in extending the metric labeling problem to matching two sentences where the objective function value is used as the similarity score between sentences. Since a one-to-one matching between words is not required for the aforementioned problem, rounding phase is not needed. Machine learning techniques such as SVM or k-nearest neighbor can be applied to the similarity scores obtained via metric labeling for deciding about the sentiment value of a query sentence. Metric labeling can be applied to match entire reviews or individual sentences from reviews. Since the latter constitutes the building blocks of the former, we will focus on matching sentences. Generalization of the concept to entire reviews can be build up on the basis of this initial study.

Applying metric labeling to sentence matching problem requires preprocessing of the dataset to represent sentences as directed graphs. Each word in a sentence has a corresponding node in the graph whose features are the POS and NE tag of the word, and the word itself. Tools such as Stanford POS tagger and named entity recognizer can be used for obtaining these tags. Each word can also be described as a vector within a language model space. In our preliminary trial, we used the English language model of Mikolov et al. which is trained by word2vec system using Google news dataset. The model contains three million words, each of which are represented by 300-dimensional vectors. Relations between words are represented by directed edges in the graph which may be defined as one of the following three types: word order edges, dependency edges and coreference edges. Words that follow each other in the sentence are connected by word order edges that point from a word to the next. Edges that are obtained by the dependency parse tree of the sentence is used as dependency edges. Coreferencing words are connected with bi-directional coreference edges. We used Stanford dependency parser and Stanford coreference resolution system for obtaining the aforementioned relations between words in our preliminary investigation.

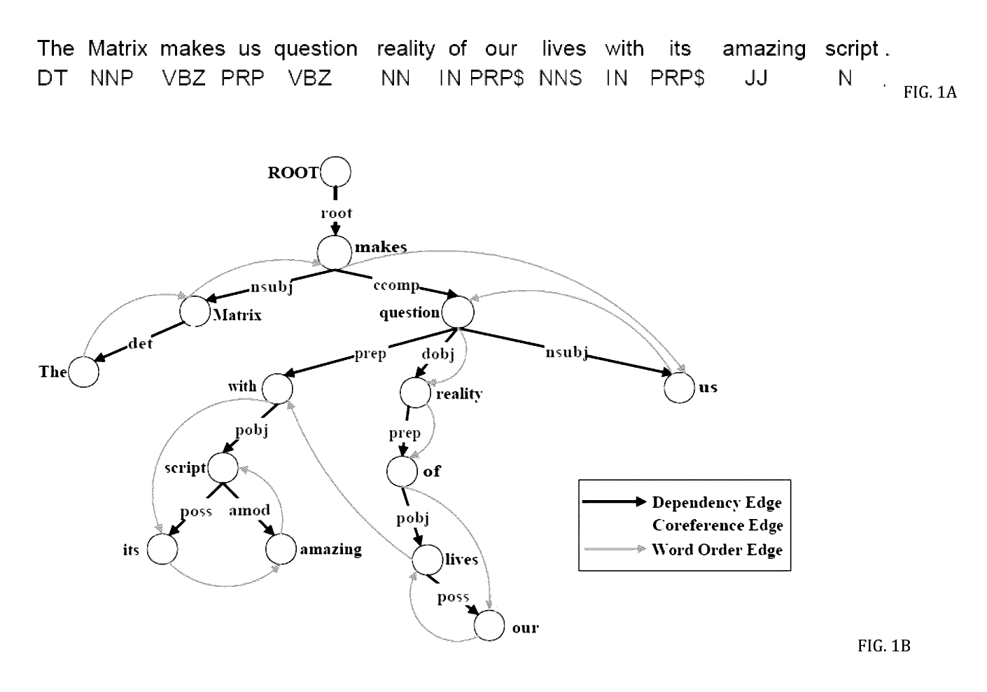

FIGS. 1A-1B show exemplary graph representation of a sample sentence. FIG. 1A show a sample sentence where acronyms written in red are the POS tags of the corresponding words such as “JJ” and “PRP$” represent adjective and possessive pronoun, respectively. In FIG. 1B, acronyms written on dependency edges represent the type of relation between two endpoints of the edge such as “amod” and “ccomp” representing adjectival modifier and clausal complement, respectively.

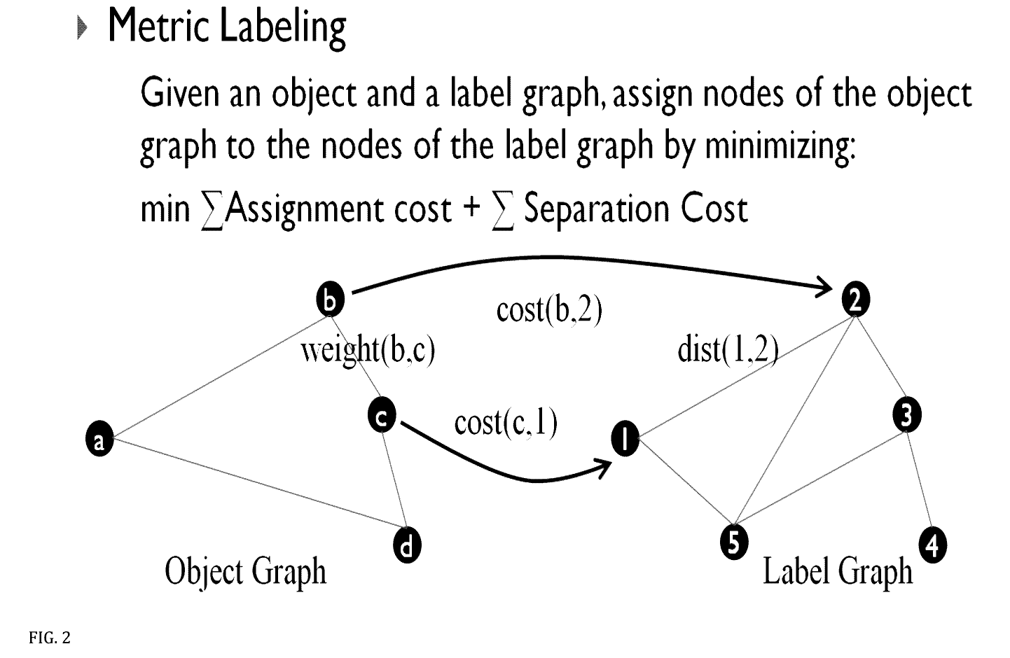

FIG. 2 shows an exemplary process for metric labeling. In this process, given an object and a label graph, assign nodes of the object graph to the nodes of the label graph by minimizing:

min ΣAssignment cost+ΣSeparation Cost.

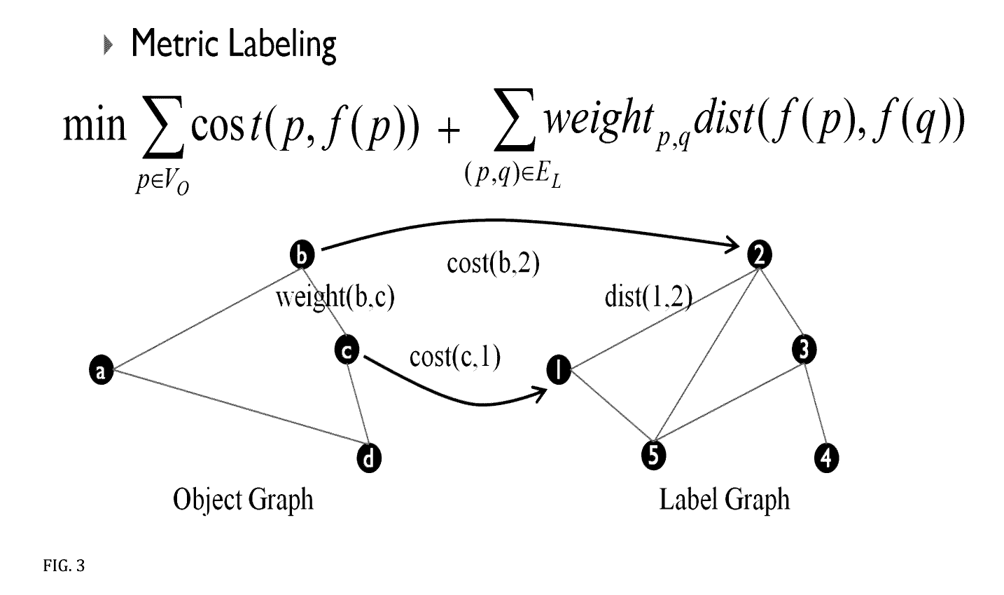

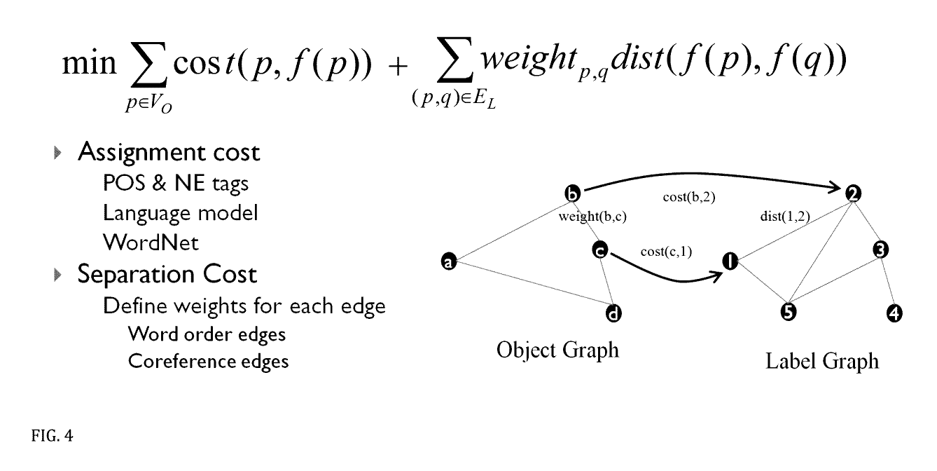

FIGS. 3-4 show another exemplary process for metric labeling by minimizing cost and distribution weight as follows:

$$min {\sum }_{p ∈ {V}_{O}}^{ } cos \text{t} ( p , f ( p ) ) + {\sum }_{( p , q ) ∈ {E}_{L}}^{ } {weight}_{p , q} dist ( f ( p ) , f ( q ) )$$

Assignment cost
POS & NE tags
Language model
WordNet

Separation Cost

Define weights for each edge
Word order edges
Coreference edges

Since each type of edge represents a different relation, we can associate distinct weights for each edge type which can be determined empirically. The graph obtained after embedding may not satisfy the metric property. Therefore, the linear programming formulation of metric labeling problem cannot be used to solve this problem since it requires embedding of a metric graph into an HST. Thus, we use the quadratic programming formulation:

$${min}_{s . t .} α {{\sum }_{p ∈ P}^{ } {\sum }_{a ∈ L}^{ }}_{\begin{matrix}{\sum }_{a ∈ L}^{ } {x}_{p , a} = 1 , \\ {x}_{p , a} \leq 1 ,\end{matrix}} {c}_{p , a} \cdot {x}_{p , a} + ( 1 - α ) {\sum }_{p ∈ P}^{ } {\sum }_{q ∈ P}^{ } {w}_{p , q} {{\sum }_{a ∈ L}^{ } {\sum }_{b ∈ L}^{ }}_{\begin{matrix}∀ p ∈ P \\ p ∈ P , a ∈ L\end{matrix}} {d}_{a , b} \cdot {x}_{p , a} \cdot {x}_{q , b}$$

where c_{p,a} represents the cost of assigning query sentence word (i.e., object node) p to dataset sentence word (i.e., label node) a, d_{a,b} represents the distance between dataset sentence words a and b, and α is the parameter to control the balance between assignment and separation costs.

In graph representations of sentences, cost of assigning an object node to a label node can be calculated as a combination of three factors: vector representation of the word, its POS tag, and the NE tag. Vector representation of words from language model can be used by calculating the cosine distance between two vectors. Words can also be assigned a similarity score according to their dictionary features such as assigning higher similarity if two words are synonyms or hyponyms. WordNet is a lexical database for English, which groups words into sets of cognitive synonyms. Results of our preliminary experiments demonstrate that use of language model outperforms WordNet based similarity measures. We also take the POS and NE tags into account while determining the similarity score. This is especially important to distinguish two words that are same but used within different contexts. The following two sentences is an example of such a case over the word rolling: “Rolling her eyes, she started to walk away” vs “Rolling Stones was his favorite rock band”. (POS, NE) tags for the word “Rolling” will be (verb, none) in the first sentence while it is (proper noun, organization) in the second. Even though the vector representation will be the same for both words, their similarity score will be set low. To calculate the separation cost, a distance measure needs to be defined over the graph representation of sentences. Reciprocal of the edge weights can be used as the distance measure between two nodes. Since there might be several directed edges from a node a to a node b, such edges can be represented as a single heavier edge whose weight is the sum of original edges.

The preliminary results presented in the previous section shows that the proposed method is promising although the experiment is performed on a small portion of the dataset. It is our hypothesis that increasing size of the dataset will directly improve the success rate of the proposed method. To this end, we are going to perform experiments on larger datasets. As the coefficients that are used in the calculation of word similarities were assigned by a human coder, one might think of better assignments that might lead to better success rates. Therefore, we are interested in investigating parameter space of the coefficients used in assignment and separation cost. Objective function can be rewritten parametrically as follows:

$$Q ( Φ , Ψ ) = α {\sum }_{p ∈ P}^{ } {\sum }_{a ∈ L}^{ } {C}_{Φ} ( p , a ) \cdot {x}_{p , a} + ( 1 - α ) {\sum }_{p ∈ P}^{ } {\sum }_{q ∈ P}^{ } {w}_{Ψ} ( p , q ) {\sum }_{a ∈ L}^{ } {\sum }_{b ∈ L}^{ } {D}_{Ψ} ( a , b ) \cdot {x}_{p , a} \cdot {x}_{q , b}$$

where Φ is the set of weights consisting of contribution of language model, POS tag, and NE tag in word similarity calculation, and ψ is the set of constants consisting of edge weights for word order, coreference, and dependency edges. Parameter space can be investigated using machine learning tools such as grid search or gradient descent.

Using k-NN for determining the sentiment value of a query sentence requires comparing the sentence with all other sentences in the dataset. Thus, running time performance of proposed method is adversely effected by the size of the underlying similarity matrix. We expect SVM to be applicable since it can give us support vectors (i.e., a smaller set of sentences in our case) which represents the characteristics of classes that we would like to separate. This can improve the running time performance since number of sentences to compare to query sentence will be reduced. We can apply metric labeling for SVM with the graph kernel. We also envision a system for a graph kernel that maintains pairwise relationships in matching while satisfying Mercer's condition.

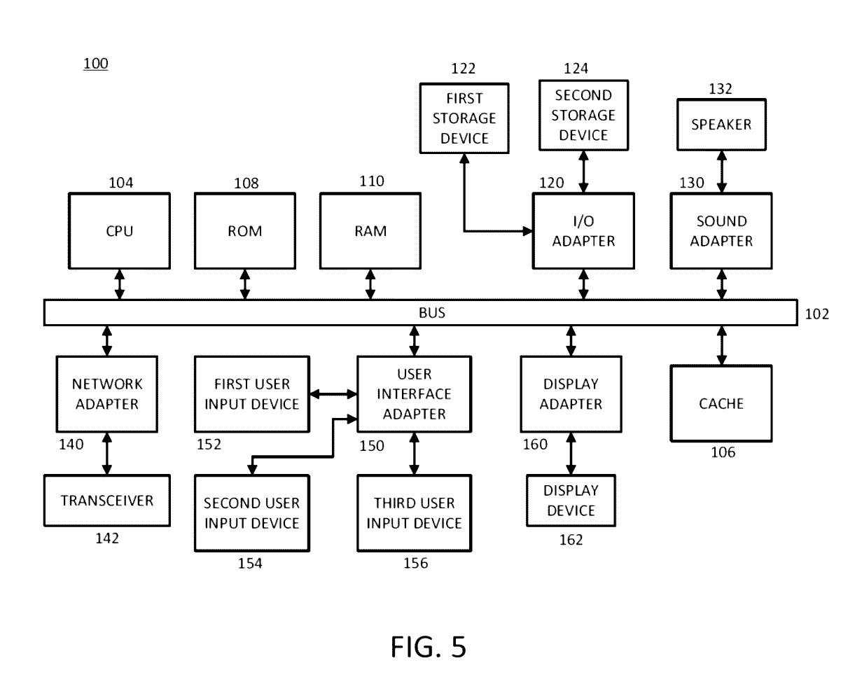

Referring now to FIG. 5, an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for Natural Language Processing (NLP), comprising:
applying metric labeling to sentence matching problem by preprocessing a dataset of sentences into objects graphs and label graphs;
given an object graph and a label graph, assigning nodes of the object graph to the nodes of the label graph by minimizing an objective function including an assignment cost and a separation cost; and
applying the metric labeling to matching two sentences where the objective function value is used as a similarity score between sentences for classification, clustering, or ranking.

2. The method of claim 1, comprising preprocessing of the dataset to represent sentences as directed graphs.

3. The method of claim 1, wherein each word in a sentence has a corresponding node in the graph whose features include POS and NE tags of the word, and the word itself.

4. The method of claim 1, comprising representing relations between words by directed edges in the graph.

5. The method of claim 1, wherein the relations comprise one of the following three types: word order edges, dependency edges and coreference edges.

6. The method of claim 1, wherein w that follow each other in a sentence are connected by word order edges that point from a word to the next word.

7. The method of claim 1, comprising obtaining edges by a dependency parse tree of the sentence used as dependency edges.

8. The method of claim 1, comprising connecting coreferencing words with bidirectional coreference edges.

9. The method of claim 1, wherein each word comprises a vector within a language model space.

10. The method of claim 1, comprising applying a quadratic programming formulation:
$${min}_{s . t .} α {{\sum }_{p ∈ P}^{ } {\sum }_{a ∈ L}^{ }}_{\begin{matrix}{\sum }_{a ∈ L}^{ } {x}_{p , a} = 1 , \\ {x}_{p , a} \leq 1 ,\end{matrix}} {c}_{p , a} \cdot {x}_{p , a} + ( 1 - α ) {\sum }_{p ∈ P}^{ } {\sum }_{q ∈ P}^{ } {w}_{p , q} {{\sum }_{a ∈ L}^{ } {\sum }_{b ∈ L}^{ }}_{\begin{matrix}∀ p ∈ P \\ p ∈ P , a ∈ L\end{matrix}} {d}_{a , b} \cdot {x}_{p , a} \cdot {x}_{q , b}$$
where c_{p,a} represents the cost of assigning query sentence word (i.e., object node) p to dataset sentence word (i.e., label node) a, d_{a,b} represents the distance between dataset sentence words a and b, and α is the parameter to control a balance between assignment and separation costs.

11. The method of claim 1, comprising determining a parametric objective function as follows:
$$Q ( Φ , Ψ ) = α {\sum }_{p ∈ P}^{ } {\sum }_{a ∈ L}^{ } {C}_{Φ} ( p , a ) \cdot {x}_{p , a} + ( 1 - α ) {\sum }_{p ∈ P}^{ } {\sum }_{q ∈ P}^{ } {w}_{Ψ} ( p , q ) {\sum }_{a ∈ L}^{ } {\sum }_{b ∈ L}^{ } {D}_{Ψ} ( a , b ) \cdot {x}_{p , a} \cdot {x}_{q , b}$$
where Φ is the set of weights consisting of contribution of language model, POS tag, and NE tag in word similarity calculation, and ψ is the set of constants consisting of edge weights for word order, coreference, and dependency edges. Parameter space can be investigated using machine learning tools such as grid search or gradient descent.

12. The method of claim 1, comprising determining applying support vectors with a smaller set of sentences which represents characteristics of classes to be separated.

13. The method of claim 1, comprising determining a sentiment value of a query sentence using k-NN.

14. The method of claim 1, comprising determining metric labeling for a supervised learning machine (SVM) with the graph kernel.

15. The method of claim 1, comprising determining a graph kernel that maintains pairwise relationships in matching while satisfying Mercer's condition.

16. The method of claim 1, comprising training targeted language models for word similarities.

17. The method of claim 1, comprising training weights for cutting edge weights.

18. The method of claim 1, comprising comparing with sentiment treebank graphs of idioms and phrases.

19. A system for Natural Language Processing (NLP), comprising:
a processor;
computer readable code for applying metric labeling to sentence matching problem by preprocessing a dataset of sentences into objects and label graphs;
computer readable code for assigning nodes of the object graph to the nodes of the label graph by minimizing an objective function including an assignment cost and a separation cost; and
computer readable code for applying the metric labeling to matching two sentences where the objective function value is used as the similarity score between sentences.

20. The system of claim 19, comprising a cloud-based server to recognize sentiments.
